(19) United States
(12) Patent Application Publication
(10) Pub. No.: US 2018/0199342 A1
(43) Pub. Date: Jul. 12, 2018

(54) BACKGROUND SCAN WITH DYNAMIC TIME AND FREQUENCY SWITCHING

(71) Applicant: QUALCOMM Incorporated, San Diego, CA (US)

(72) Inventors: Kapil RAI, Sunnyvale, CA (US); Meriam REZK, Campbell, CA (US); Mahboobul ALEM, Fremont, CA (US); Amod BODAS, Cupertino, CA (US)

(21) Appl. No.: 15/866,437

(22) Filed: Jan. 9, 2018

Related U.S. Application Data
(60) Provisional application No. 62/444,233, filed on Jan. 9, 2017.

(51) Int. Cl. H04W 72/04; H04W 16/14; H04W 24/08; H04J 14/02; H04B 1/04; G01S 7/02

(52) U.S. Cl. CPC H04W 72/0453; H04W 16/14; H04W 24/08; H04W 88/06; H04B 1/0475; G01S 7/021; H04J 14/0298

(57) ABSTRACT

A method, an apparatus, and a computer-readable medium for wireless communication are provided. An apparatus is configured to communicate over a primary channel via a first set of antennas and over the primary via a second set of antennas. The second set of antennas is switched from the primary channel to a secondary channel when the communication over the primary channel is idle. A channel availability checks (CACs) is performed on the secondary channel when the primary channel is idle to determine whether radar signals are detected on the secondary channel.

### CROSS-REFERENCE TO RELATED APPLICATION(S)

This application claims the benefit of U.S. Provisional Application No. 62/444,233 entitled “Background Scan with Dynamic Time and Frequency Switching” filed on Jan. 9, 2017, which is expressly incorporated by reference herein in its entirety.

### BACKGROUND

### Field

The present disclosure relates generally to communication systems, and more particularly, to background scans with dynamic time and/or frequency switching.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), wireless wide area network (WWAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., an access point) for wireless communication. The apparatus may be configured to communicate over a primary channel via a first set of antennas and over the primary channel via a second set of antennas. The apparatus may be configured to switch the second set of antennas from the primary channel to a secondary channel when the communicating over the primary channel is idle. The apparatus may be configured to perform a clear availability check (CAC) on the secondary channel when the primary channel is idle to determine whether one or more radar signals are detected on the secondary channel.

### BRIEF DESCRIPTION OF THE DRAWINGS

FIG. 1 shows an example wireless communication system in which aspects of the present disclosure may be employed.

FIGS. 2A and 2B illustrate example configurations of a device performing radar detection.

FIGS. 3A and 3B illustrate example configurations of a device performing radar detection in channel bonding mode with fast channel switching (FCS).

FIG. 4 is an example diagram of a wireless network employing an example method of background scanning with dynamic time and frequency switching.

FIG. 5 illustrates a first example diagram of dynamic time frequency switching for single channel mode.

FIG. 6 illustrates a second example diagram of dynamic time frequency switching for single channel mode.

FIGS. 7A and 7B illustrate example diagrams of dynamic time frequency switching for channel bonding mode.

FIG. 8 illustrates an example diagram of dynamic time frequency switching for channel bonding mode with three chains.

FIG. 9 is a flowchart showing an example method of performing background scanning with dynamic time and frequency switching in accordance with one aspect described herein.

FIG. 10 is a diagram illustrating an example of a hardware implementation for an apparatus employing a processing system.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs” Or UEs). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C). When referring to a set of elements (e.g., a set of antennas), the set may have multiple elements (e.g., multiple antennas) or just one element (e.g., one antenna).

As discussed above, certain devices described herein may implement the 802.11 standard, for example. Such devices, whether used as a STA or an AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

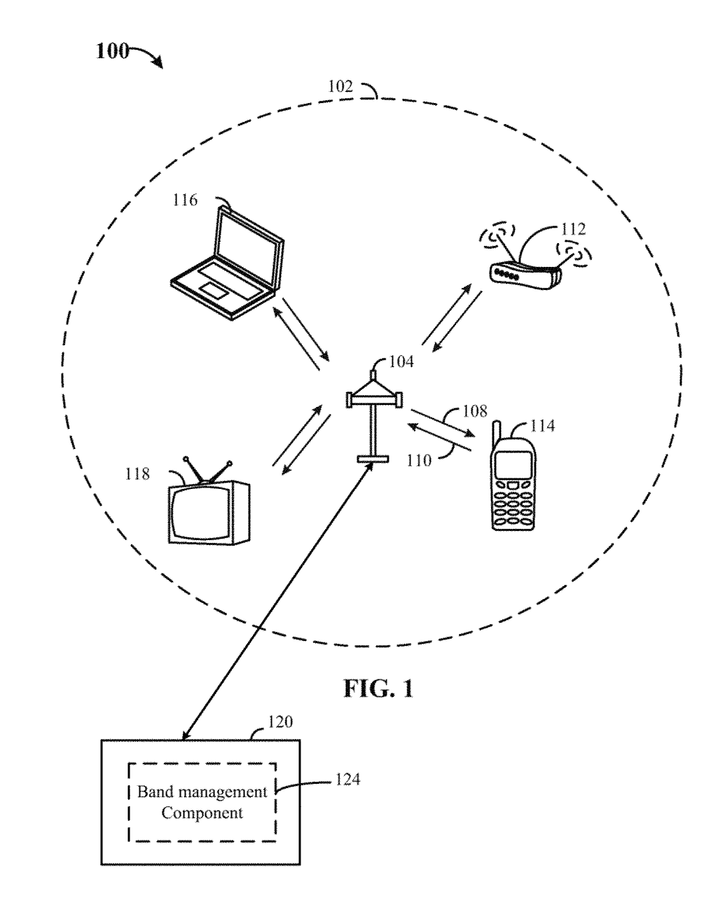

FIG. 1 shows an example wireless communication system 100 in which aspects of the present disclosure may be employed. The wireless communication system 100 may operate pursuant to one or more wireless standards, such as the 802.11 standard. The wireless communication system 100 may include an AP 104, which communicates with STAs (e.g., STAs 112, 114, 116, and 118). In the present disclosure, the term STA may be used interchangeably with the term UE. In one aspect, the AP 104 may be an access point in a WLAN, for example. The wireless communication system 100 may include a core network 120.

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include a band management component 124 configured to perform procedures related to managing communications on various channels, including performing background scans for radar detection. The band management component 124 may be configured to operate in a channel bonding mode. The channel bonding mode may enable communications over a primary channel and a secondary channel and may enable CACs for radar detection. In an aspect, the channel bonding mode may also enable communications over a tertiary channel. The band management component 124 may be configured to perform radar detection (e.g., in-service monitoring (ISM)) on the primary channel to determine if radar signals are detected on the primary channel based on a first set of signals received via a first set of antennas and a second set of signals received via a second set of antennas. The first and second set of antennas may be tuned to the primary channel. The band management component 124 may be configured to perform a CAC on the secondary channel when the primary channel is idle to determine whether radar signals are detected on the secondary channel based on a third set of signals received via the second set of antennas by switching the second set of antennas from an initial channel to the secondary channel. The band management component 124 may be configured to store results from at least one of the radar detection or the CAC.

Ever-increasing wireless traffic has escalated the need for additional spectral resources. Currently, wireless communication mainly occurs in the spectrum from 700 MHz to 2.6 GHz, but soaring wireless traffic has led wireless operators and equipment manufacturers to develop products that use the unlicensed spectrum (e.g., spectrum residing in the 5 GHz band). Previously, the 5 GHz band was primarily used for radar signaling such as in radio-navigation, satellite transmissions, radio-location, weather, etc. Increasingly, however, the 5 GHz band is being used by individual users for wireless communication, such as Wi-Fi communication. By enabling mixed use of 5 GHz channels, interference to radar transmission and reception may increase. To avoid interference with radar systems, wireless devices operating in one or more channels of the 5 GHz band may need to comply with radar detection and dynamic frequency selection (DFS) conformance rules. Before transmitting on one or more channels of the 5 GHz band, a DFS device (e.g., a WLAN AP, a UE, or a STA that implements Wi-Fi-Direct and/or soft AP modes) may independently detect radar by performing CACs to listen for the presence of radar signals. If radar is detected on a channel, then the DFS device may not use the channel and may flag the channel as unavailable. If radar is not detected on the channel (e.g., if a channel is free from radar for at least 60 seconds), then the DFS device may use the 5 GHz channel for communication.

Because the 5 GHz band includes radar (or DFS) channels, APs may be required to continuously scan and detect for radar in certain 5 GHz channels and move a current communication channel to a non-DFS channel or a DFS channel that is free from radar upon detecting radar signals on the current communication channel. However, performing CAC and moving the communication channel may interrupt data communications. For example, real-time sensitive applications, such as video streaming, may require and benefit from uninterrupted traffic. For real-time sensitive applications, the wait time to move channels from the CAC process may be too lengthy (e.g., over a minute). A need exists to enable advanced background sensing of DFS channels to enable fast channel switching to DFS channels. As used herein, reference to a DFS channel may refer to a radar channel. Similarly, reference herein to a radar channel may refer to a DFS channel. In some examples, the terms radar and DFS may be synonymous.

Other applications may also benefit from fast channel switching for DFS channels. For example, an AP may be paired with a range extender. The range extender may have two simultaneous links on different channels, one to communicate with the AP and the other to communicate with a client device of the range extender. In a European regulatory domain, there may be only one 80 megahertz (MHz) channel that is non-DFS. As such, the AP may use the non-DFS channel to communicate with the range extender, which means there is no non-DFS channel for the range extender to use to communicate with the client device. When radar signals are detected on the DFS channel used by the range extender, the communication link may collapse unless another DFS channel was scanned in the background and kept ready. Similarly, US and other regulatory domains may provide two non-DFS channels. However, the problem remains when multiple APs are operating in overlapping areas. Together, the APs may occupy all of the non-DFS channels, leaving the DFS channels for the range extenders.

A device may be configured to perform a background scan for radar signals using a dedicated Wi-Fi chip (e.g., an auxiliary radar detector attached to a separate transceiver). A WLAN MIMO transceiver may receive signals via one or more antennas The WLAN MIMO transceiver may provide the signals to a radar detector to perform ISM in order to determine if any radar signals are present on a current channel (or primary channel). The auxiliary radar detector may attempt to detect radar signals on a secondary channel via a dedicated antenna. If radar signals are determined to be present on the primary channel, then the device may move the communication session to the secondary channel. This scheme, however, requires an auxiliary radar detector and the separate antenna, which may increase costs and chip size.

A device may be configured to perform a background scan for radar signals using a shared antenna/RF component, a dedicated chain/synthesizer (e.g., an auxiliary radar detector) and digital circuitry. A radar detector may also be provided to perform in-service monitoring in order to determine if any radar signals are present on a current channel (or primary channel). The auxiliary radar detector may not have its own antenna. The auxiliary radar detector may share at least one antenna with a WLAN MIMO transceiver. A shared RF component may determine whether the received signals at the shared antenna are to be routed to the WLAN MIMO transceiver or to the auxiliary radar detector. When the received signals are routed to the auxiliary radar detector, the auxiliary radar detector may utilize the shared antenna to perform a background scan by monitoring a secondary channel and determining if radar signals are present on the secondary channel. Subsequently, from in-service monitoring, if the radar detector determines that radar is present on the primary channel, then the device may move the communication session to the secondary channel. This scheme, however, requires shared RF circuitry and also an auxiliary radar detector, which may increase costs and chip size.

A device may perform a background scan for radar signals using a borrowed chain. A radar detector may receive signals from a WLAN MIMO transceiver via one or more antennas. The radar detector may perform in-service monitoring in order to determine if any radar signals are present on a current channel (or primary channel). An auxiliary radar detector may share at least one antenna with the WLAN MIMO transceiver. The WLAN MIMO transceiver may operate 4×4 chain but may be reduced to a 3×3 chain when a background scan is performed. During the background scan, the 3×3 chain may listen on a first frequency (f1) while a 1×1 chain may listen on a second frequency (f2). That is, packets may continue to be received over the first frequency. Subsequently, from in-service monitoring, if the radar detector determines that radar is present on the primary channel, then the device may o move the communication session to the secondary channel that is free from radar according to the auxiliary radar detector. This scheme, however, requires a reduction in the RX chain while communication occurs in the primary channel, temporarily limiting performance.

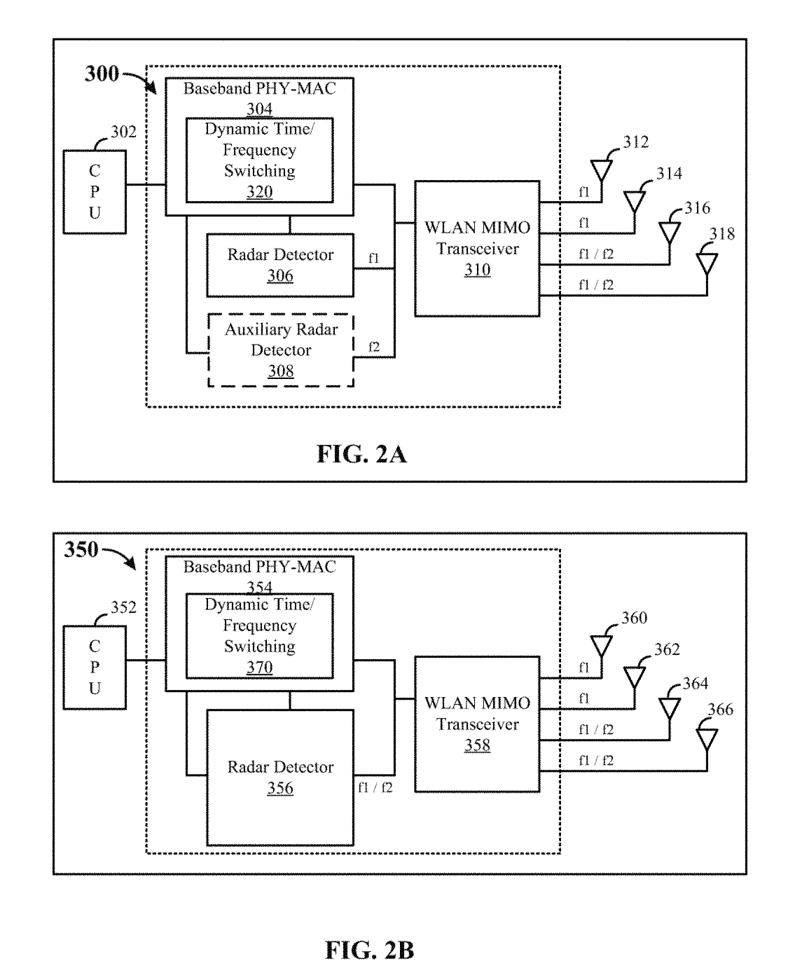

FIGS. 2A and 2B respectively illustrate example configurations 300 and 350 of a device configured to perform radar detection in accordance with the techniques described herein. FIG. 2A illustrate a device 300 having a CPU 302, a baseband PHY-MAC 304, a radar detector 306, an auxiliary radar detector 308, a WLAN MIMO transceiver 310, and antennas 312, 314, 316, and 318. In FIG. 2A, a CPU 302 may be configured to control the baseband PHY-MAC 304 that manages communication over the physical and MAC layers. The CPU 302 may be configured to operate the radar detector 306, the auxiliary radar detector 308, and the WLAN MIMO transceiver 310. The radar detector 306 and the auxiliary radar detector 308 may receive signals from the WLAN MIMO transceiver 310. In one configuration, the WLAN MIMO transceiver 310 may have a plurality of antennas, such as the four antennas 312, 314, 316, and 318 shown in the example of FIG. 2A. The WLAN MIMO transceiver 310 may be configured to listen for and receive data at a first frequency (f1) using a first set of antennas, such as antennas 312 and 314. The first frequency f1 may be a channel within the 5 GHz WiFi band. With the remaining set of antennas (e.g., antennas 316 and 318 in this example), the WLAN MIMO transceiver may be configured to listen for data from f1, or listen for radar at a second frequency (f2). As used herein, reference to a frequency may, in some examples, refer to a channel or a frequency of a channel. Similarly, reference to a channel may, in some examples, refer to a frequency or a channel including the frequency. In an aspect, f1 may correspond to a primary channel (i.e., a first channel), and f2 may correspond to a secondary channel (i.e., a second channel). By default, with the remaining two antennas 316 and 318, the WLAN MIMO transceiver 310 may be configured to listen for radar at f2. When a data packet arrives, as detected by the first two antennas 312 and 314, the remaining two antennas 316 and 318 may switch to f1 and, subsequently, return to f2 when the data packet ends. The baseband PHY-MAC 304 may have a dynamic time/frequency switching module 320 that is configured to perform the switching of the antennas 316 and 318. For example, the dynamic time/frequency switching module 320 may be configured to switch antennas 316 and 318 from being configured to transmit and/or receive information at f1 to being configured to transmit and/or receive information at f2. In an aspect, dynamic time/frequency switching module 320 may be configured to utilize a first-come-first-served approach, in which the remaining two antennas 316 and 318, having switched to f1 if the data packet arrives first, do not listen to radar on f2 until the packet ends. Similarly, if a radar pulse shows up first on either f1 (or on f2), the data packet on f1 may be ignored by all antennas (or the remaining antennas 316 and 318) until the radar pulse detection process is completed. Referring to FIG. 2A, the radar detector 306 may be configured to monitor f1 for radar signals and the auxiliary radar detector 308 may be configured to monitor f2 for radar signals. If radar signals are detected on f1, and f2 is deemed free of radar by having observed the mandatory CAC period using the dynamic time-frequency switched background listening, then the dynamic time/frequency switching module 320 may be configured to switch the communication channel from f1 to f2 without having to perform a CAC after radar is detected and before switching over to f2.

FIG. 2B illustrate a device 350 having a CPU 352, a baseband PHY-MAC 354, a radar detector 356, a WLAN MIMO transceiver 358, and antennas 360, 362, 364, and 364. Unlike FIG. 2A, which has two radar detectors, FIG. 2B enables background scan with a single radar detector (e.g., the radar detector 356). The operation of FIG. 2B is similar to FIG. 2A in which a CPU 352 is configured to control the baseband PHY-MAC 354 that operates the radar detector 356 and the WLAN MIMO transceiver 358. The WLAN MIMO transceiver 358 is coupled to four antennas 360, 362, 364 and 366. The radar detector 356 may be configured to monitor for radar signals at f1 via the WLAN MIMO transceiver 358 and the first set of antennas 360 and 362. The second set of antennas 364 and 366 may switch between f1 and f2. In FIG. 2B, when the second set of antennas 364 and 366 are receiving radar signals at f2, then the radar detector 356 may be configured to monitor for radar on f2 via the WLAN MIMO transceiver 358 and the second set of antennas 364 and 366. When the second set of antennas 364 and 366 are receiving data packets at f1, then the radar detector 356 may be configured to monitor for radar at the communication channel associated with f1 (in-service monitoring). In an aspect, the radar detector 356 in FIG. 2B may be configured to select between f1 and f2 to monitor by being coupled to the second set of antennas 364, 366 that switch between f1 and f2. In an aspect, the radar detector 356 may also be configured to monitor f1 by being coupled to the first set of antennas 360 and 362. In other words, the radar detector 356 may accept inputs from all antennas and may be configured to select one or more antennas for further processing. The baseband PHY-MAC 354 may have a dynamic time/frequency switching module 370 that is configured to switch between the antennas. By reducing the number of radar detectors, costs and chip size may be reduced. In other implementations, the device 350 may have a component that combines or selects outputs from various channels and sorts the information per channel (e.g., primary, secondary, or any other number) to determine which channel contains radar signals.

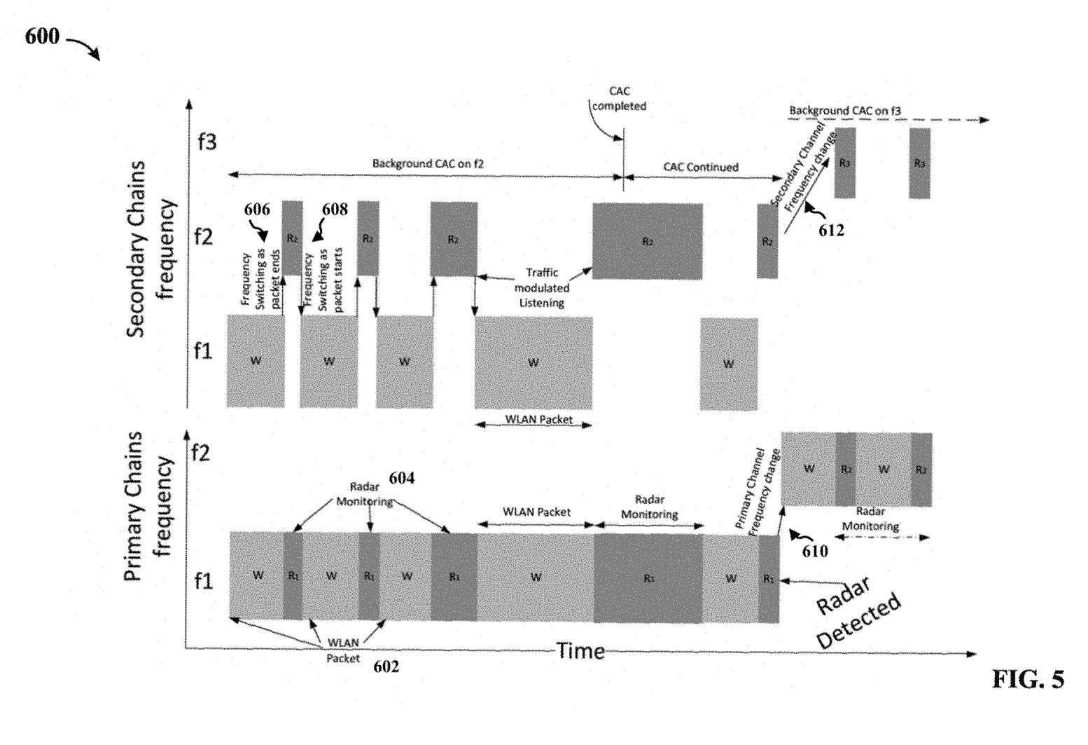

In an aspect, when switching the second set of antennas from f1 to f2, the switch may be based on traffic duration of the primary channel and the switch may be in both time and frequency. FIGS. 5-8 discussed below show examples of the switching involved. Primary chains may exhibit time domain switching whereas the secondary chains may show both time and frequency domain switching. In some examples, as used here, references to a chain may refer to an antenna and an RF front-end signal pathway through a WLAN MIMO transceiver for data packet communication or radar detection.

Although FIGS. 2A and 2B illustrate examples of a WLAN MIMO transceiver with four antennas, any other number of antennas may be used. With an increasing number of antennas, greater throughput may be realized for data and/or additional channels may be monitored for background scans. In FIGS. 2A and 2B, a device may be configured to operate in a single channel mode for providing network services (e.g., in the MAC layer and above) but in a channel bonding mode in the physical layer. The baseband PHY-MAC 354 may act as a bridge between different modes in the physical and the MAC layers. The single channel mode provides a single channel for communication (e.g., a primary channel) with other devices, whereas the channel bonding mode may provide multiple channels for communication (e.g., a primary channel and a secondary channel) with other devices. As such, in channel bonding mode, the device may communicate with other devices using the primary channel and use the secondary channel for background radar scans.

In an aspect, referring to FIG. 2A, a first synthesizer within the WLAN MIMO transceiver 310 may be coupled to the antennas 312, 314, 316, 318 and a second synthesizer may be coupled to the antennas 316, 318. Thus, the antennas 316, 318 may be coupled to the first synthesizer or the second synthesizer. The first synthesizer may be used to tune to f1 while the second synthesizer may be used to tune to f2. The second synthesizer may be operated independently from the first synthesizer so as not to disturb network operation of the primary channel associated with the first synthesizer when radar detection is performed on the secondary channel.

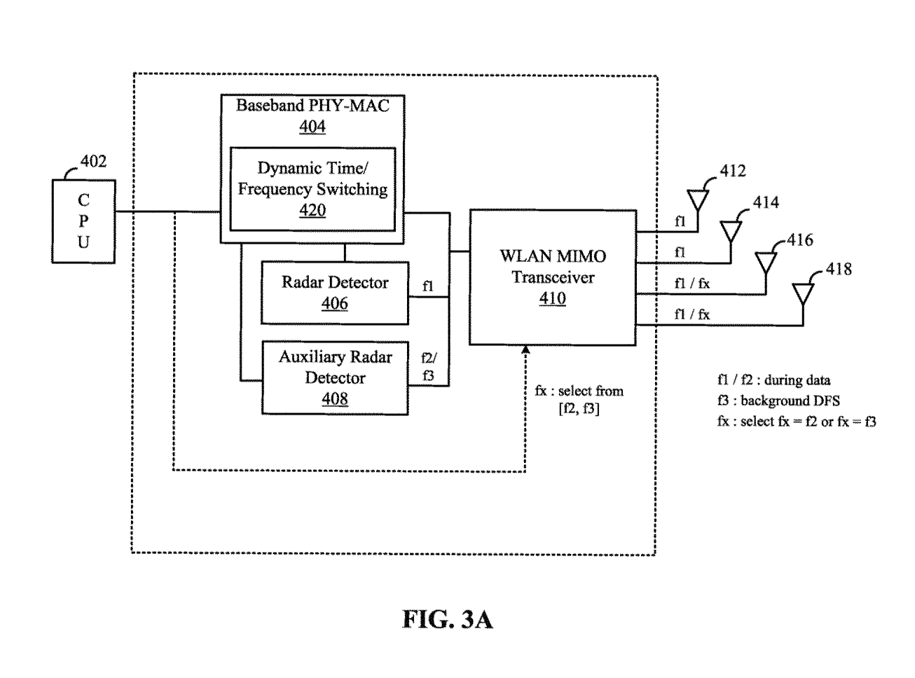

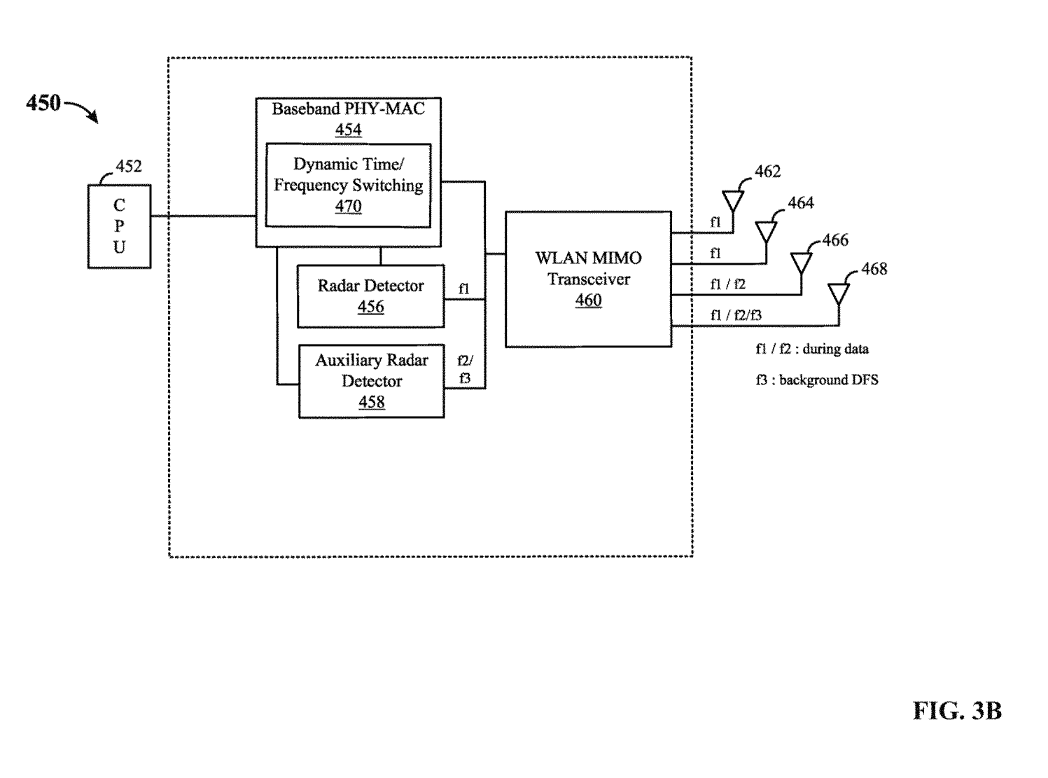

FIGS. 3A and 3B illustrate example configurations 400, 450 of a device performing radar detection in channel bonding mode with fast channel switching (FCS). Referring to FIG. 3A, a CPU 402 may operate to control a baseband PHY-MAC 404 that manages communication over the physical and MAC layers and operates a radar detector 406, an auxiliary radar detector 408, and a WLAN MIMO transceiver 410. The radar detector 406 and the auxiliary radar detector 408 may receive signals from the WLAN MIMO transceiver 410. In one configuration, the WLAN MIMO transceiver 410 may have four antennas 412, 414, 416, 418. With the first two antennas 412, 414 (e.g., a first set of antennas), the WLAN MIMO transceiver 410 may listen for and receive data at first frequency (f1). With the remaining two antennas 416, 418 (e.g., a second set of antennas), the transceiver may listen for data on either f1 and/or a second frequency (f2) or listen for radar to perform CAC at a third frequency (f3). As shown in FIG. 3A, a dynamic time/frequency switching module 420 in the baseband PHY-MAC 404 may operate the WLAN MIMO transceiver 410 to select between f1, f2, or f3. In an aspect, f1 may correspond to a primary channel, f3 may correspond to a secondary channel, and f2 may correspond to a tertiary channel. As such, the primary and tertiary channels may be used to receive data and the secondary channel may be used for background scans. In an aspect, the baseband component 404 may include software for selecting between f1, f2, or f3. When the device provides services in single channel mode (e.g., 80 MHz packet) but operates in channel bonding mode, then f1 may be selected for antennas 412, 414, 416, 418 for purposes of data communication, and f2 may be used by antennas 416, 418 to detect radar when the primary channel associated with f1 is idle. When the device provides network services in channel bonding mode (e.g., 80+80 MHz packet), then f1 may be selected for antennas 412, 414 and f2 may be selected for antennas 416, 418 when the device communicates data. Subsequently, f3 may be selected for radar detection. When data arrives, as detected by the first two antennas 412, 414, the remaining two antennas 416, 418 may switch to f2 and, subsequently, return to f3 when the data packet ends. In aspect, this scheme may utilize a first-come-first-served approach, in which the antennas 416, 418, having switched to f2 when the data packet arrives first, does not listen to radar on f3 until the packet ends. Similarly, if radar shows up first on f3, the packet on f2 may be ignored by the antennas 416, 418. Referring to FIG. 3A, the radar detector 406 may perform ISM by monitoring f1 for radar signals and the auxiliary radar detector 408 may monitor f2 and f3 for radar signals.

In an aspect, with FCS, the device need not provide any announcement regarding the channel change (e.g., channel change between f2 and f3 in the second set of antennas 416, 418). In another aspect, when the channel changes for the second set of antennas 416, 418, communications over the primary channel may continue uninterrupted. In another aspect, when the device receives traffic of 80 MHz bandwidth, the device may instantaneously switch all antennas 412, 414, 416, 418 to the primary channel, away from the secondary and tertiary channels.

Referring to FIG. 3B, a CPU 452 may operate to control a baseband PHY-MAC 454 that manages communication over the physical and MAC layers and operates a radar detector 456, an auxiliary radar detector 458, and a WLAN MIMO transceiver 460. The radar detector 456 and the auxiliary radar detector 458 may receive signals from the WLAN MIMO transceiver 460. In one configuration, the WLAN MIMO transceiver 460 may have four antennas 462, 464, 466, 468. With the first two antennas 462, 464 (e.g., a first set of antennas), the WLAN MIMO transceiver 460 may listen for and receive data at first frequency (f1). With the remaining two antennas 466, 468 (e.g., a second set of antennas), the transceiver may listen for data on either f1 and/or a second frequency (f2) or listen for radar at a third frequency (f3). In an aspect, f1 may correspond to a primary channel, f3 may correspond to a secondary channel, and f2 may correspond to a tertiary channel. As such, the primary and tertiary channels may be used to receive data and the secondary channel may be used to detect radar signals. In an aspect, the WLAN MIMO transceiver 460 may have four RX chains, one for each antenna. One RX chain associated with the antenna 466 may be able to switch between f1 and f2. For an 80 MHz packet, the RX chain may switch to f1, and for a 160 MHz packet, the RX chain may switch to or stay at f2. Another RX chain associated with the antenna 468 may be able to perform a 3-way switch between f1, f2, and f3. In an aspect, the RX chain may, as a matter of default, be tuned to D. When an 80 MHz packet is detected, the RX chain may switch to f1, and when a 160 MHz packet is detected, the RX chain may switch to f2; subsequently, the RX chain may revert to f3 for background scans. In another aspect, the WLAN MIMO transceiver 460 may include 3 synthesizers—a first synthesizer for tuning to f1, a second synthesizer for tuning to f2, and a third synthesizer for tuning to f3. When the RX chain associated with the antenna 468 switches from one frequency to another, the RX chain may choose from among the three synthesizers. In this aspect, software intervention may not be needed.

Referring to FIG. 3B, a dynamic time/frequency switching module 470 in the baseband PHY-MAC 454 may select among f1, f2, and/or f3. When the device provides services in single channel mode (e.g., 80 MHz packet) but operates in channel bonding mode, then f1 may be selected for antennas 462, 464, 466, 468 for purposes of data communication, and f2 may be used by antennas 466, 468 to detect radar when the primary channel associated with f1 is idle. When the device provides network services in channel bonding mode (e.g., 80+80 MHz packet), then f1 may be selected for antennas 462, 464 and f2 may be selected for antennas 466, 468 when the device communicates data. Subsequently, f3 may be selected for radar detection. When data arrives, as detected by the first two antennas 462, 464, the remaining two antennas 466, 468 may switch to f2 and, subsequently, return to f3 when the data packet ends. In aspect, this scheme may utilize a first-come-first-served approach, in which the antennas 466, 468, having switched to f2 when the data packet arrives first, does not listen to radar on f3 until the packet ends. Similarly, if radar shows up first on f3, the data packet on f2 may be ignored by the antennas 466, 468, or by just the antenna 468. Referring to FIG. 3B, the radar detector 466 may monitor f1 for radar signals and the auxiliary radar detector 458 may monitor f2 and f3 for radar signals.

In an aspect, with FCS, the device need not provide any announcement regarding the channel change (e.g., channel change between f2 and f3 in the second set of antennas 466, 468). In another aspect, when the channel changes for the second set of antennas 466, 468, communications over the primary channel may continue uninterrupted. In another aspect, when the device receives traffic of 80 MHz bandwidth, the device may instantaneously switch all antennas 462, 464, 466, 468 to the primary channel, away from the secondary and tertiary channels.

To perform FCS, the device may maintain calibration tables for the secondary and tertiary channels. For example, the device may maintain all calibration tables for the tertiary channel and maintain only NF CAL and RxDCO CAL tables for the secondary channel to enable radar detection. In another aspect, the device may keep timer and logic for switching frequencies. The logic may include fixed duty cycles or adaptive duty cycles for the secondary and tertiary channels. For example, the antennas 416, 418 may listen on the secondary channel 50% of the time and on the tertiary channel 50% of the time, switching between the two channels every 50 ms. The switching frequency and length of time listening on the secondary and the tertiary channels may be adapted based on recent history of throughput and time spent on each of the channels. In another aspect, if the clients of the device go into DTIM/BMPS mode (a sleep state/mode), then the secondary channel on which radar is scanned may be given more time because there is less likely to be traffic on the other channels. In another aspect, if the device receives an 160 MHz RTS from a client, then the device may respond with an appropriate bandwidth CTS (e.g., 80 MHz CTS when the tertiary channel is being scanned or 160 MHz CTS when the secondary channel is being monitored) or defer the CAC monitoring on the secondary channel.

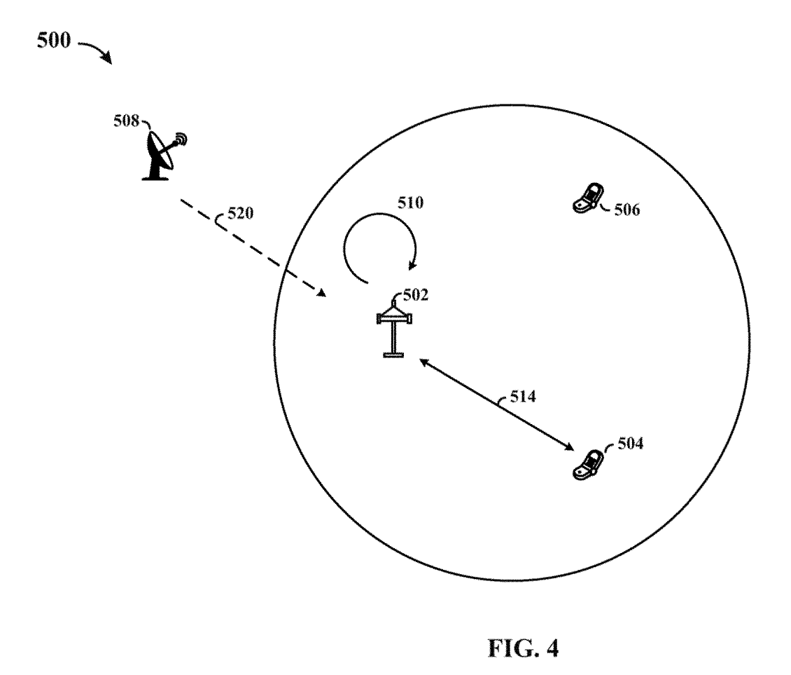

FIG. 4 is an example diagram 500 of a wireless network employing an example method of background scanning with dynamic time and frequency switching. Referring to FIG. 4, an AP 502 may operate in single channel mode or channel bonding mode. In single channel mode, the AP 502 may communicate over a single channel (e.g., an 80 MHz channel). In channel bonding mode, the AP 502 may communicate over two 80 MHz channels (or two 40 MHz channels). In one aspect, the 80 MHz channels may not be contiguous in frequency, and in this aspect, the AP 502 may communicate over different channels. In another aspect, the 80 MHz channels may be contiguous in frequency, and in this aspect, the two 80 MHz channels may be considered a single 160 MHz channel. In another aspect, the AP 502 may be able to communicate over a 160 MHz channel in a single channel mode.

Upon power-up, the AP 502 may boot up 510 in 160 MHz/80 MHz+80 MHz bandwidth mode and channel bonding mode. That is, the AP 502 may operate in channel bonding mode and be configured to communicate over two noncontiguous 80 MHz channels or two contiguous 80 MHz channels. In channel bonding mode, the AP 502 may support at least two channels—a primary channel and a secondary channel. In one aspect, the secondary channel may be referred to as a tertiary channel. If the primary channel (e.g., a primary 80 MHz channel) is a non-DFS channel (non-radar channel) and the secondary channel (e.g., a secondary 80 MHz channel) is a DFS channel (radar channel), then the AP 502 may perform a CAC in the secondary channel to determine if any radar signals 520 are detected from a radar 508. If the primary channel is a DFS channel and the secondary channel is a non-DFS channel, then the AP 502 may perform a CAC in the primary channel to determine any radar signals 520 are detected from the radar 508. If both the primary and secondary channels are DFS channels, then the AP 502 may perform a joint-CAC over the entire 160 or (80+80) MHz bandwidth to determine whether any radar signals 520 are detected from the radar 508. In an aspect, the primary and secondary channels may be contiguous. When performing a CAC, the AP 502 may detect radar signals 520 based on a determination of whether a set of radar signal characteristics associated with any detected radar signal is present (e.g., radar signals coded using radar pattern types or raw received radar pulse data).

During a network configuration state, the AP 502 may attempt to discover device capabilities of nearby and/or associated devices. For example, STAs 504, 506 may be associated with the AP 502, and during or after association, the AP 502 may attempt to discover the capabilities of the STAs 504, 506. Based on the capabilities of the STAs 504, 506, the AP 502 may determine to advertise single channel mode or channel bonding mode functionality.

### Advertise Single Channel Mode, Operate in Channel Bonding Mode

In one configuration, the STAs 504, 506 may only be able to operate in an 80 MHz bandwidth mode. When no 160 MHz or 80+80 MHz capable devices are found, the AP 502 may advertise a single channel mode for providing a network service to the STAs 504, 506. The AP 502 may transmit (or broadcast) a beacon or a management frame indicating a single channel operation (e.g., 80 MHz channel) for providing a network service. To perform background scans for radar, however, the AP 502 may simultaneous enter into an agile mode, which is a background scan mode for radar detection. In agile mode, the AP 502 may actually be operating the physical layer at an 80+80 MHz bandwidth mode. As such, a controller (e.g., a baseband component) within the AP 502 may distinguish between the bandwidth mode being advertised in the network (e.g., 80 MHz) and the actual bandwidth mode used by the AP 502 (e.g., 80+80 MHz bandwidth mode). In an aspect, software at the AP 502, such as host layer software (e.g., TCP layer, application layer) and MAC layer software, may function in 80 MHz mode while the physical layer may be configured to operate in 80+80 MHz mode. Firmware may be used to bridge the bandwidth mismatch between the physical layer and the MAC/host layer. By enabling the physical layer to operate at an 80+80 MHz bandwidth, the AP 502 may communicate over both a primary channel (e.g., having 80 MHz bandwidth) and a secondary channel (e.g., having 80 MHz bandwidth). The AP 502 may communicate 514 with the STA 504, for example, over the primary channel (f1) that has an 80 MHz bandwidth and use the secondary channel (f2) for background scan (or CAC).

The AP 502 may perform radar detection. In an aspect, the AP 502 may perform radar detection on the primary channel (in-service monitoring). The AP 502 may be the device in FIG. 2A, for example, and may receive a first set of signals on the first set of antennas (312, 314) and receive a second set of signals on the second set of antennas (316, 318). When the primary channel is idle, the AP 502 may switch or tune the second set of antennas 316, 318 to the secondary channel and perform a CAC on the secondary channel. By waiting for the primary channel to be idle before performing the CAC, any throughput reduction as a result of switching the antennas is diminished. In an aspect, the AP 502 may utilize a first-come-first-served system in which the AP 502 does not listen to the primary channel when the AP 502 first detects radar signals on the secondary channel. The AP 502 may wait until the radar detection is completed before monitoring signals on the primary channel. Similarly, while first receiving data from the primary channel, the AP 502 may not detect radar signals on the secondary channel until the primary channel becomes idle. In another aspect, the AP 502 may continue to communicate via the primary channel (e.g., using the first set of antennas) while performing a CAC on the secondary channel (e.g., using the second set of antennas). In another aspect, the AP 502 may perform a joint CAC simultaneously on both the primary and the secondary channels when both channels are idle (e.g., carry no traffic) to determine whether radar signals are detected on either or both channels based on signals received via the first set of antennas and on signals received via the second set of antennas. The first set of antennas may be tuned to the primary channel, and the second set of antennas may be tuned to the secondary channel. In an aspect, the AP 502 may perform joint CAC upon start-up or boot up or at another time.

In one configuration, such as for an ETSI deployment, the AP may generate a channel availability list (CAL) based on the background scan. If the secondary channel does not contain radar signals 520 from the radar 508, for example, then the AP 502 may add the secondary channel to the channel availability list. Subsequently, the AP 502 may select a next channel (e.g., another 80 MHz channel) to be monitored as the new secondary channel. The AP 502 may observe the new secondary channel for an entire CAC duration (e.g., 60 seconds or some other duration). In an aspect, the CAC duration may be altered (e.g., increased or decreased) for purposes of meeting detection probabilities (or statistical criterion) for a particular radar type. Certain radar types may require a lengthier CAC duration, while others may not. The process of waiting for the primary channel to become idle to monitor radar signals on a secondary channel, adding the secondary channel to the CAL if no radar signals are detected, and selecting another secondary channel to monitor may be repeated until all the possible channels have been monitored and a full channel availability list has been populated.

In another configuration (e.g., for ETSI or FCC deployment), if radar signals 520 are detected on the secondary channel (e.g., 80 MHz secondary channel), then the AP 502 may place the secondary channel on a non-occupancy list (NOL). In an aspect, the AP 502, based on the location of the radar signals within the channel, the AP 502 may update status information for 40 MHz and 20 MHz channels within the 80 MHz channel. Although the entire 80 MHz bandwidth of the secondary channel may not be available due to the presence of radar signals 520, the AP 502 may block only the affected 20 MHz or 40 MHz segments of the 80 MHz channel, and make the remaining 20 MHz and/or 40 MHz segments available. In this aspect, the AP 502 may add the remaining 20 MHz and/or 40 MHz segments that are available to the CAL. In another aspect, the AP 502 may mask a subset of the subcarriers of the 80 MHz channel found to contain radar signals and make the remaining subcarriers of the 80 MHz channel available for use. In another aspect, if radar signals 520 are detected on the primary channel, then the AP 502 may place the primary channel on the NOL.

In another aspect, while performing radar detection with the background scan, the AP 502 may return a predetermined number of receive chains to the secondary channel when the primary channel is idle.

While providing network services in the single channel mode and operating in the channel bonding mode, if radar signals 520 are detected on the primary channel based on in-service monitoring, then the AP 502 may, in one aspect, immediately switch to a radar free channel without performing a CAC on the radar free channel after radar signals are detected on the primary channel. In one example, under an ETSI deployment, the AP 502 may switch to a first channel or any other channel listed in the CAL. In another aspect, instead of switching channels, the AP 502 may switch the bandwidth on the primary channel. For example, instead of communicating over the entire 80 MHz bandwidth, the AP 502 may communicate over a reduced bandwidth by masking subcarriers found to contain radar signals and communicating over the remaining subcarriers. As an example, the primary channel may be an 80 MHz channel that is reduced to a 40 MHz channel based on detected radar signals.

In another example, under an FCC deployment, the AP 502 may not be able to utilize a CAL because a channel may have to be free from radar for at least 60 seconds before switching to it but channels on the CAL may not have been monitored for radar signals within the last 60 seconds. In this example, the AP 502 may, in one aspect, switch the primary channel to the secondary channel when the radar signals 520 are detected. Under FCC deployment, when the AP 502 does not use a CAL, the AP 502 may continuously monitor the same secondary channel while the primary channel is idle. Accordingly, when radar signals 520 are detected on the primary channel, having completed the mandated CAC duration and being in extended-CAC monitoring (continuous monitoring while the primary channel is idle), the AP 502 may immediately switch the primary channel to the secondary channel, and assign a new channel to the secondary channel for monitoring.

In another aspect, instead of switching the channel, the AP 502 may reduce the bandwidth of the primary channel. For example, the radar may be a narrowband radar as opposed to a wideband radar. In one instance, the bandwidth may be reduced by masking one or more subcarriers found to contain radar signals 520. In another instance, certain segments of the channel may be blocked. In one case, an 80 MHz channel may have four 20 MHz segments: 20-1, 20-2, 20-3, 20-4. If segment 20-4 has radar and segments 20-1, 20-2, 20-3 are free from radar, then instead of switching to another channel, the AP 502 may operate in a 40 MHz bandwidth using the segments 20-1 and 20-2 for example. In another case, if radar was detected in segment 20-3, but segments 20-1, 20-2, and 20-4 are free from radar, then the AP 502 may operate in a 40 MHz bandwidth using segments 20-1 and 20-2 if the radar is not at band center. In another case if radar is on segments 20-2, but segments 20-1, 20-3, and 20-4 are free from radar, then if radar is at the band center, the AP 502 may change the channel unless regulatory requirements are met, in which case a 40 MHz channel may be used with segments 20-3 and 20-4 even when the radar is at band center. Otherwise, if the radar is not at band center, the AP 502 may operate in a 20 MHz mode, provided spurious components outside of the segment may be kept below regulatory levels. In yet another case, if segment 20-1 has radar but segments 20-2, 20-3, and 20-4 are free from radar, then the AP 502 may be required to move the primary or leftmost 20 MHz band. This may be done instantaneously and the OMN may be used to announce the change in the primary 20 MHz segment. Analog frequency change may not be necessary, which would enable the channel move time to be accommodated quickly without interruption.

In the above mentioned cases, when the AP 502 changes the bandwidth and/or the channel, the AP 502 may transmit a bandwidth change announcement or a channel change announcement and move to the next channel in the CAL. The AP 502 may give preference to a DFS channel over a non-DFS channel based on how crowded the non-DFS channel is. When radar is detected on a particular channel/bandwidth, the AP 502 may add the channel and/or bandwidth to the NOL and start a timer to return to the channel/bandwidth on the NOL after at least 30 minutes or some other time duration. Although the aforementioned techniques are discussed with respect to narrow band radars, the techniques may also be applied to wideband radars that can occupy up to 20 MHz of bandwidth. Depending upon the bandwidth of the radar, its overlap with different bandwidth segments, and the choice of the primary 20 MHz channel, a channel switch and/or a bandwidth switch may be made. For example, if the starting chirp frequency is greater than the band center, then the AP 502 may operate in 40 MHz. If the starting chirp frequency is less than the band center and the primary 20 MHz is unaffected, then the AP 502 may operate in a 20 MHz channel. Otherwise, the AP 502 may change the channel.

In an aspect, the AP 502 may determine whether to switch the bandwidth of the primary channel or switch the channel completely based on network throughput requirements and/or a type of traffic carried on the primary channel. For example, if network throughput requirements may be met even with reduced channel bandwidth, then the AP 502 may opt to remain in the primary channel but reduce the bandwidth. In another example, if the type of traffic contains real-time sensitive data such as voice and/or video data, then the AP 502 may opt to switch to a different channel to reduce interference and packet loss.

### Advertise and Operate Channel Bonding Mode

In another configuration, the STA 504 may be capable of operation in the 160/80+80 MHz bandwidth mode. In this configuration, instead of advertising the single channel mode, the AP 502 may transmit or broadcast a beacon/management frame that indicates a channel bonding mode functionality for providing a network service. In one aspect, when operating in the channel bonding mode, the AP 502 may suspend background scans for radar signals. The AP 502 may communicate with the STA 504 over the primary and secondary channels in the 160/80+80 MHz bandwidth mode. If radar signals 520 appear in the secondary channel (as detected with ISM), then the AP 502 may switch to a 80 MHz bandwidth communication. Similarly, if radar signals 520 appear in the primary channel, the AP 502 may switch the primary channel to the secondary channel, thereby switching both channel (primary to secondary) and bandwidth (e.g., 160 MHz to 80 MHz).

In another aspect, the AP 502 may continue to perform background scans even in channel bonding mode. In this aspect, the AP 502 may be configured similarly to the device as shown in FIG. 3A or in FIG. 3B. The AP 502 may communicate data over the primary channel (f1) and a tertiary channel (f2) and perform a CAC on the secondary channel (f3). Although one or more aspects this disclosure refer to f2 as the tertiary channel and f3 as the secondary channel, such labels are simply for ease of reference, and f2 may be referred to as the secondary channel while f3 may be referred to as the tertiary channel. In this aspect, as shown in FIG. 3A, the first set of antennas may be tuned to the primary channel, and the second set of antennas may be tuned to the secondary channel and/or the tertiary channel. When the primary channel is idle, the second set of antennas may switch from the tertiary channel to the secondary channel, and the AP 502 may perform a CAC on the secondary channel. By waiting for the primary channel to be idle before performing the CAC, any throughput reduction may be diminished. In an aspect, the AP 502 may utilize a first-come-first-served system in which the AP 502 does not listen to the primary channel or the tertiary channel when the AP 502 first receives radar signals 520 on the secondary channel. The AP 502 may wait until the radar detection is completed before monitoring signals on the primary/tertiary channels. Similarly, while first receiving data from the primary channel or the tertiary channel, the AP 502 may not detect radar signals 520 on the secondary channel until the primary channel and/or tertiary channel become idle.

In one configuration, such as for an ETSI deployment, the AP may generate a CAL based on the CAC of the secondary channel. If the secondary channel does not contain radar signals 520 from the radar 508, for example, then the AP 502 may add the secondary channel to the channel availability list. Subsequently, the AP 502 may select a next channel (e.g., another 80 MHz channel) to be monitored as the new secondary channel. The AP 502 may observe the new secondary channel for an entire CAC duration (e.g., 60 seconds or some other duration). In an aspect, the CAC duration may be increased or decreased for purposes of meeting detection probabilities for a particular radar type. Certain radar types may require a lengthier CAC duration, while others may not. The process of waiting for the primary channel to become idle to monitor radar signals on a secondary channel, adding the secondary channel to the CAL if no radars are detected, and selecting another secondary channel to monitor may be repeated until all the possible channels have been monitored and a full channel availability list has been populated.

In another configuration (e.g., for ETSI or FCC deployment), if radar signals 520 are detected on the secondary channel (e.g., a 80 MHz secondary channel), then the AP 502 may place the 80 MHz secondary channel on a NOL. In an aspect, the AP 502, based on the location of the radar signals within the channel, may update status information for 40 MHz and 20 MHz channels within the 80 MHz channel. Although the entire 80 MHz bandwidth of the secondary channel may not be available due to radar signals 520, the AP 502 may block only the affected 20 MHz or 40 MHz segments of the 80 MHz channel, and make the remaining 20 MHz and/or 40 MHz segments available. In this aspect, the AP 502 may add the remaining 20 MHz and/or 40 MHz segments that are available to the CAL. In another aspect, the AP 502 may mask a subset of the subcarriers of the 80 MHz channel found to contain radar signals and make the remaining subcarriers of the 80 MHz channel available for use. In another aspect, if radar signals 520 are detected on the primary channel, then the AP 502 may place the primary channel on the NOL.

In an aspect, when the AP 502 performs background scan while providing network services in the channel bonding mode, the available bandwidth for communication may be reduced. For example, the communication bandwidth available for network services may drop from 160 MHz to 80 MHz. Different schemes may be utilized to reduce packet loss when the AP 502 experiences a reduction in bandwidth. In one scheme, the AP 502 may utilize an information element (IE) that can be sent to the STA 504 during association or as an OMN. The IE may include, for example, a vendor identifier or another indication instructing the STA 504 to use dynamic bandwidth management using request to send (RTS)/clear to send (CTS) when the STA 504 operates in 160/80+80 bandwidth mode. That is, when the STA 504 has traffic to send to the AP 502, the STA 504 may first transmit a 160 MHz RTS to the AP 502. If the AP 502 is performing background scan and does not have 160 MHz available for communication, then the AP 502 may not provide CTS or only a partial bandwidth CTS; otherwise, the AP 502 may transmit a 160 MHz CTS in response to the 160 MHz RTS. Without receiving the 160 MHz CTS, the STA 504 may not transmit or transmit only in 80 MHz or a smaller bandwidth.

In another aspect, STAs may not recognize the IE sent from the AP 502 and may not transmit a 160 MHz RTS to the AP 502. If the STAs transmit data in the 160/80+80 MHz bandwidth mode while the AP 502 is listening for radar signals, the STAs may experience packet loss. After sufficient packet loss, such STAs may adapt to an 80 MHz mode and cease transmitting in the 160 MHz mode, for example.

In another aspect, STAs may perform a network level assessment of interference in a secondary channel. STAs may perform clear channel assessment (CCA) at random times, generating a histogram based on the CCA, and computing a probability of the STA seeing a busy status with respect to the secondary channel. If the estimated probability is higher than a threshold, then the STA may turn on an RTS/CTS mechanism when communicating in a 160 MHz bandwidth. In an aspect, the AP 502 may use the information to assess whether the AP 502 risks affecting 160 MHz traffic due to packet-loss while the AP 502 is performing a background scan on the secondary channel.

While providing network services and operating in the channel bonding mode, if radar is detected on the primary channel based on in-service monitoring, then the AP 502 may, in one aspect, immediately switch to a radar free channel without performing a CAC on the radar free channel after radar signals are detected on the primary channel and may continue to operate in the 160/80+80 MHz mode. In one example, under an ETSI deployment, the AP 502 may switch the primary channel to a first channel or any other channel listed in the CAL. If radar is detected on the tertiary channel, the AP 502 may also switch the tertiary channel to any channel listed in the CAL, without performing a CAC on the channel after radar is detected on the tertiary channel. In another aspect, instead of switching channels, the AP 502 may switch the bandwidth on the primary channel. For example, instead of communicating over the entire 80 MHz bandwidth of a channel, the AP 502 may communicate over a reduced bandwidth by masking subcarriers found to contain radar signals and communicating over the remaining subcarriers. Similarly, if radar signals 520 are detected on the tertiary channel, then the AP 502 may reduce the bandwidth of the tertiary channel.

In another example, under an FCC deployment, the AP 502 may not be able to utilize a CAL because a channel may have to be free from radar for at least 60 seconds before switching to it but channels on the CAL may not have been monitored for radar within the last 60 seconds. In this example, if the AP 502 detects radar signals on the primary channel, the AP 502 may, in one aspect, switch the primary channel to the secondary channel. When radar signals 520 are detected on the primary channel, the AP 502, having been in the extended-CAC monitoring mode (e.g., an extended duration or continuous duration of CAC monitoring), may immediately switch the primary channel to the secondary channel, and assign a new channel to the secondary channel for monitoring. In another aspect, the AP 502 may switch the primary channel to the tertiary channel instantaneously as the tertiary channel was being continuously monitored and found to be radar-free. In this aspect, the AP 502 may operate in single channel mode temporarily until the secondary channel becomes available (e.g., after a CAC is successful completed). In another aspect, if radar is detected on the tertiary channel, then the AP 502 may switch the tertiary channel to the secondary channel. If radar is detected on both the primary and tertiary channels, then the AP 502 may switch the primary channel to the secondary channel and change from channel bonding mode to single channel mode. In another aspect, instead of switching the channel, the AP 502 may reduce the bandwidth of the primary channel and/or the tertiary channel by masking one or more subcarriers found to contain radar signals 520. In an aspect, the AP 502 may determine whether to switch the bandwidth of the primary channel or switch the channel completely based on network throughput requirements and/or a type of traffic carried on the primary channel. For example, if network throughput requirements may be met even with reduced channel bandwidth, then the AP 502 may opt to remain in the primary channel but reduce the bandwidth. In another example, if the type of traffic contains real-time sensitive data such as voice and/or video data, then the AP 502 may opt to switch to a different channel to reduce interference and packet loss.

FIG. 5 illustrates a first example diagram 600 of dynamic time frequency switching for single channel mode. Referring to FIG. 5, the AP 502, providing network services in single channel mode, may have primary and secondary chains within a transceiver. The primary chain may be associated with a first set of antennas and the secondary chain may be associated with a second set of antennas. Initially, the AP 502 may receive WLAN packets (W) 602 over f1 using the primary chain and the secondary chain. The AP 502 may receive WLAN packets 602 over a primary channel located at f1. During the idle times for f1, in between the WLAN packets 602, the primary chain may listen for radar signals on f1 (R₁) at 604. Also during the idle times, the secondary chain may switch frequencies to a secondary channel located at f2 and listen for radar signals on f2 (R₂) at 606. When packets are expected on the primary channel, the secondary chain may switch back from the secondary channel to the primary channel to receive the WLAN packet 602 on the primary channel at 608. As shown in FIG. 5, the AP 502 may perform traffic modulated listening on the secondary channel such that the secondary chain tunes to the secondary channel only when a WLAN packet is not being received on the primary channel. After performing CAC on the secondary channel for a time duration, the CAC may be complete and the AP 502 may determine that the secondary channel is free from radar signals. In one aspect, to maximize the listening time for radar signals on the secondary channel in CAC, the secondary chain may switch from the secondary channel to the primary channel only after receipt of a WLAN packet is confirmed on the primary channel. For example, the primary chain may confirm the receipt of a WLAN packet through synchronization and decoding of signaling fields of the WLAN packet to avoid unnecessary switching of the channels on the secondary chain when unintended energy is received. In another aspect, the detection of the radar signal on the secondary channel may be based on a weighted priority determined based on prior successful radar pulse detection conforming to valid radar characteristics. In another aspect, the detection of the radar signal on the secondary channel may be performed over multiple short time slots that occur randomly. At the start of the time slot, the secondary chain switches to the secondary channel and at the end of the time slot, the secondary chain switches to the primary channel to receive WLAN packets. The secondary chain may perform a dynamic time-frequency switching between the primary channel and the secondary channel without affecting either the radar probability of detection or data packet throughput.

If the AP 502 detects radar signals on the primary channel, then the AP 502 may switch or relocate the primary channel over to f2 and receive WLAN packets 602 on f2 at 610. The AP 502 may continue to perform ISM on the primary channel on f2.

In another aspect, because CAC was previously completed on f2, the AP 502 may relocate the secondary channel to a different frequency f3 at 612. The AP 502 may perform CAC on f3 during periods when the AP 502 is not receiving WLAN packets on f2, the new primary channel. As shown in FIG. 5, when the primary channel is idle, the AP 502 may monitor both the primary and the secondary channels for radar signals. The AP 502 may continue to monitor f3 for radar until the CAC duration has expired and the CAC is completed.

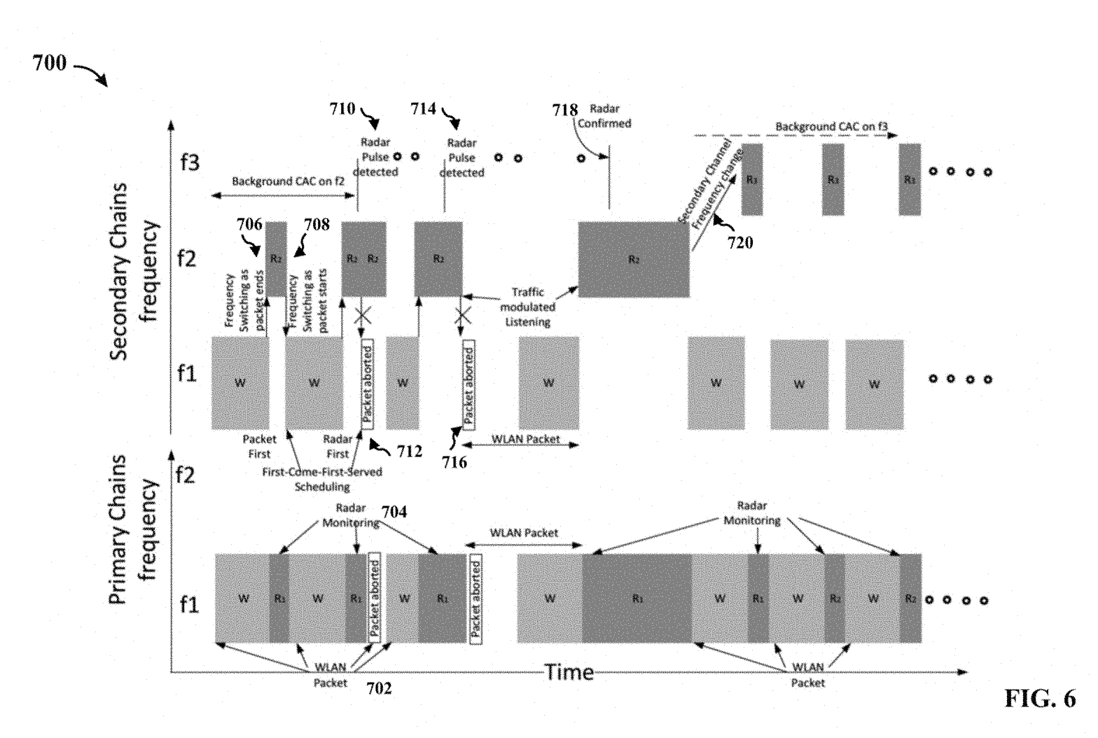

FIG. 6 illustrates a second example diagram 700 of dynamic time frequency switching in single channel mode. Unlike in FIG. 5, in which radar signals were detected on a primary channel, FIG. 6 illustrates processes for when radar signals are detected on the secondary channel. Referring to FIG. 6, the AP 502, providing network services in single channel mode, may have primary and secondary chains within a transceiver. The primary chain may be associated with a first set of antennas and the secondary chain may be associated with a second set of antennas. Initially, the AP 502 may receive WLAN packets (W) 702 over f1 using the primary chain and the secondary chain. The AP 502 may receive WLAN packets 702 over a primary channel located at f1. During the idle times for f1, in between the WLAN packets 702, the primary chain may listen for radar signals on f1 (R₁) at 704. The secondary chain may switch frequencies to a secondary channel located at f2 and listen for radar signals on f2 (R₂) at 706. When packets are expected on the primary channel, the secondary chain may switch back from the secondary channel to the primary channel to receive the WLAN packet on the primary channel at 708. The AP 502 may perform traffic modulated listening on the secondary channel such that the secondary chain tunes to the secondary channel only when a WLAN packet is not being received on the primary channel. In an aspect, while performing a background CAC on f2, the AP 502 may detect radar pulses at 710. Due to a first-come-first-served scheduling, when radar pulses are detected on f2, the AP 502 may abort or interrupt the packet reception on f1 in order to monitor the radar pulses on f2 at 712. When the radar pulses end, the AP 502 may receive WLAN packets 702 on f1. After receiving the WLAN packet 702, the AP 502 may again tune the second set of antennas to f2 and detect radar pulses. Radar pulses may again be detected at 714, and the AP 502 may continue to monitor f2 for radar pulses, which may cause a WLAN packet to be interrupted or aborted at f1 at 716. Subsequently, the AP 502 may receive another WLAN packet. After the WLAN packet is received, the AP 502 may tune the second set of antennas to f2 again to perform CAC. After monitoring f2 to detect a sufficient number of pulses, the AP 502 may determine that radar signals are present (e.g., radar is confirmed) at 718. The AP 502 may add f2 to the NOL and move the secondary chain to f3 and perform CAC on f3 at 720. As shown in FIG. 6, the AP 502 may perform CAC on f3 during idle periods associated with f1. The idle periods may be random or periodic. After performing CAC on f3, if the AP 502 determines that f3 is free from radar signals, then the AP 502 may add f3 to the CAL under ETSI deployment.

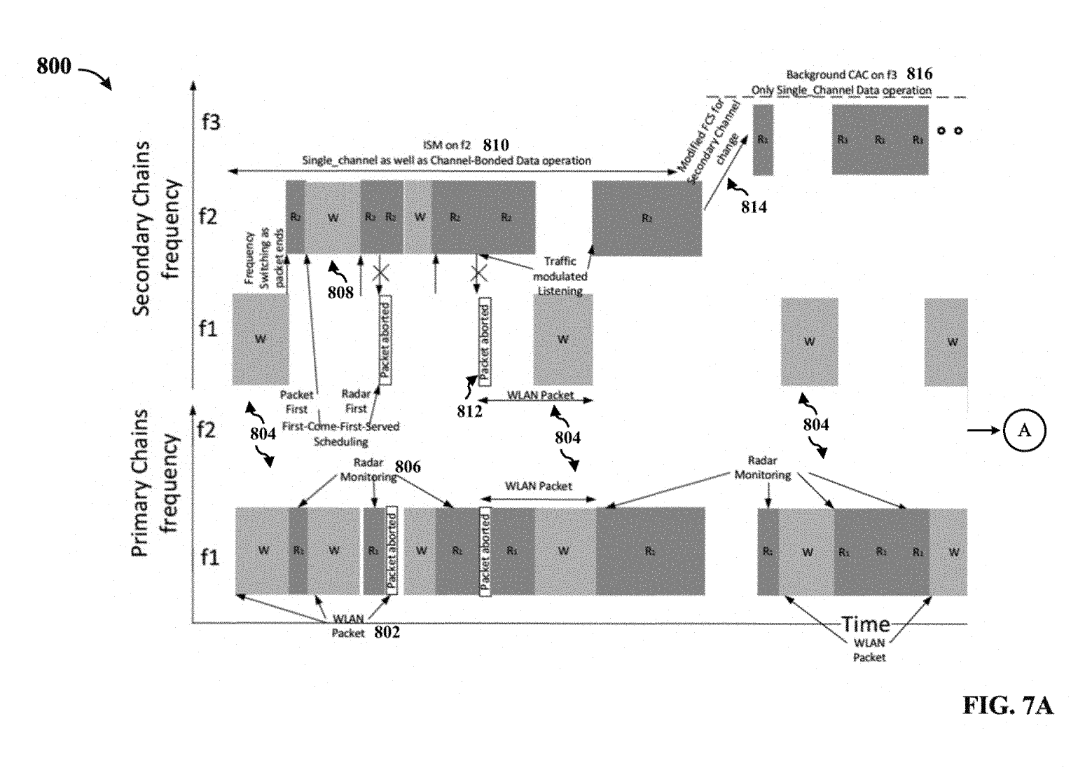

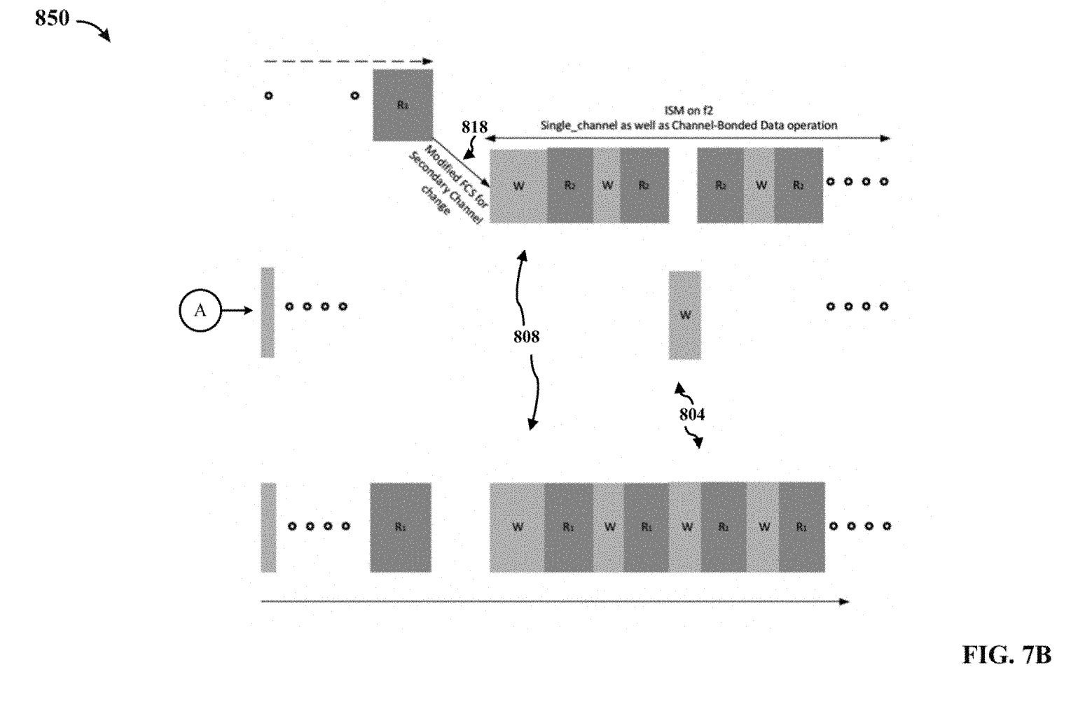

FIGS. 7A and 7B illustrate example diagrams 800, 850 of dynamic time frequency switching for channel bonding mode. Referring to FIG. 7A, the AP 502 may have primary and secondary chains. The primary chain may be associated with a first set of antennas and the secondary chain may be associated with a second set of antennas. Initially, the AP 502 may be providing network services in single channel mode and may receive WLAN packets (W) 802 over a primary channel located at f1 using the primary chain and the secondary chain at 804. During the idle times for f1 between the WLAN packets, the primary chain may listen for radar signals on f1 (R₁) at 806. Subsequently, when there is no reception of WLAN packets, the AP 502 may switch to channel bonding mode 808, and the secondary chain may switch frequencies to a tertiary channel located at f2 and receive WLAN packets 802 on f2. Together, the AP 502 may receive WLAN packets on f1 via the primary chain over the primary channel and on f2 via the secondary chain (e.g., 160 MHz packet or 80+80 MHz packet) over the tertiary channel. During idle periods on f2 when no WLAN packets are received, the AP 502 may perform ISM on f2 to detect radar signals (R₂) at 810. The AP 502 may continue to perform ISM on f1 to detect radar signals (R₁) at 806. In an aspect, as in previous examples, the AP 502 may utilize first-come-first-served scheduling such that if radar signals R₂ are detected in the tertiary channel, then WLAN packets may be interrupted in the primary channel and the tertiary channel at 812 because the AP 502 is operating in channel bonding mode. In another aspect, the AP 502 may perform traffic modulated listening on the tertiary channel such that the secondary chain performs ISM on the tertiary channel when the a WLAN packet is not being received on the primary channel at 810. In another aspect, the AP may perform CAC on a secondary channel located at f3. To perform CAC on the secondary channel, the AP 502 may perform a modified fast channel switching with respect to the secondary chain at 814. While performing CAC, the AP 502 may provide network services in single channel mode at 804, and the AP 502 may perform CAC using the secondary chain during periods when the primary channel is idle at 816. The AP 502 may also perform ISM on the primary channel using the primary chain when the primary channel is idle.

If the AP 502 detects radar signals on the primary channel, then the AP 502 may switch or relocate the primary channel over to f2 and receive WLAN packets on f2. The AP 502 may continue to perform ISM on the primary channel on f2. Continuing to FIG. 7B, after the AP 502 successfully performs CAC on the secondary channel, the AP 502 may utilize modified fast channel switching to switch the secondary chain back to the tertiary channel located on f2 at 818. The AP 502 may receive data via the primary channel using the primary chain and the tertiary channel using the secondary chain in the channel bonding mode 808, or may receive data via the primary channel using the primary chain and the secondary chain in the single channel mode 804. Although one or more aspects of this disclosure refer to the secondary chain as receiving WLAN packets on the tertiary channel located at f2 and as operating the background CAC on the secondary channel located at f3, such labels are simply for ease of reference. Another aspect may refer to the secondary chain as receiving WLAN packets on the secondary channel located at f2 and as operating the background CAC on the tertiary channel located at f3.

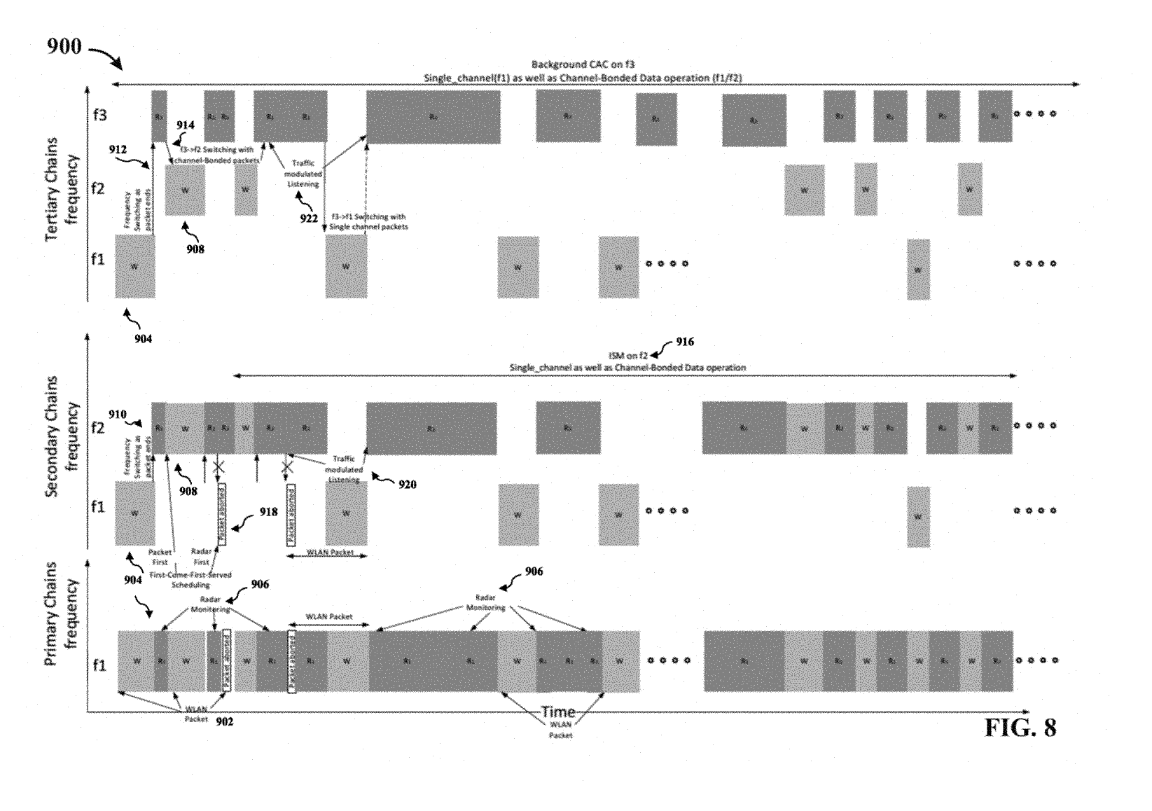

FIG. 8 illustrates an example diagram 900 of dynamic time frequency switching for channel bonding mode with three types of chains. Referring to FIG. 8, the AP 502 may have primary, secondary, and tertiary chains. The primary chain may be associated with a first set of antennas, the secondary chain may be associated with a second set of antennas, and the tertiary chain may be associated with a third set of antennas. Initially, the AP 502 may be providing network services in single channel 904 mode and may receive WLAN packets (W) 902 over f1 using the primary, secondary, and tertiary chains. The AP 502 may receive WLAN packets 902 over the primary channel located at f1. During the idle times for f1 between the WLAN packets 902, the primary chain may perform ISM by listening for radar signals on f1 (R₁) at 906. Subsequently, after the WLAN packet ends, the AP 502 may switch to channel bonding mode 908, and the secondary chain may switch frequencies at 910 to a tertiary channel located at f2 and receive WLAN packets 902 on f2. Together, the AP 502 may receive WLAN packets 902 on f1 via the primary chain over the primary channel and on f2 via the secondary chain (e.g., 160 MHz packet or 80+80 MHz packet) over the tertiary channel. The tertiary chain may switch to a secondary channel located at f3 to perform a background CAC during periods when the primary and/or tertiary channels are idle at 912. When the tertiary channel is not idle, the tertiary chain may revert to receiving WLAN packets on the tertiary channel at 914. During idle periods on f1 and f2 when no WLAN packets are received, the AP 502 may perform ISM on f2 to detect radar signals (R₂) using the secondary chain at 916 and may perform ISM on f1 to detect radar signals (R₁) using the primary chain at 906. In an aspect, as in previous examples, the AP 502 may utilize first-come-first-served scheduling such that if radar signals R₂ are detected in the tertiary channel, then WLAN packets may be interrupted in the primary channel and the tertiary channel at 918 because the AP 502 is operating in channel bonding mode. In another aspect, the AP 502 may perform traffic modulated listening on the tertiary channel at f2 at 920 such that the secondary chain performs ISM on the tertiary channel at 916 when the WLAN packet is not being received on the primary channel. Similarly, the AP 502 may perform traffic modulated listening on the secondary channel located at f3 at 922 such that the tertiary chain performs the background CAC when the primary and/or tertiary channels are idle.

If the AP 502 detects radar signals on the primary channel, then the AP 502 may switch or relocate the primary channel over to f2 and switch the tertiary channel over to f3 to continue to operate in the channel bonding mode. The AP 502 may switch the secondary channel to another frequency to perform a background CAC during periods when the primary channel located at f2 and/or the tertiary channel located at f3 are idle. In other aspects, when the AP 502 detects radar signals on the primary channel, the AP 502 may switch to the single channel mode by switching the primary channel to f2, or may operate with a reduced bandwidth. If the AP 502 detects radar signals on the tertiary channel, then the AP 502 may switch the tertiary channel over to f3 to continue to operate in the channel bonding mode. The AP 502 may switch the secondary channel to another frequency to perform a background CAC during periods when the primary located at f1 and/or tertiary channels located at f3 are idle. In other aspects, when the AP 502 detects radar signals on the tertiary channel, the AP 502 may switch to the single channel mode by switching the tertiary channel to f1, or may operate with a reduced bandwidth. If the AP 502 detects radar signals on the secondary channel located at f3 while performing the background CAC, the AP 502 may switch the secondary channel to another frequency such as f4 for the background CAC. Although one or more aspects of this disclosure refer to the secondary chain as receiving WLAN packets on the tertiary channel located at f2 and the tertiary chain as operating the background CAC on the secondary channel located at f3, such labels are simply for ease of reference. Another aspect may refer to the secondary chain as receiving WLAN packets on the secondary channel located at f2 and the tertiary chain as operating the background CAC on the tertiary channel located at D.

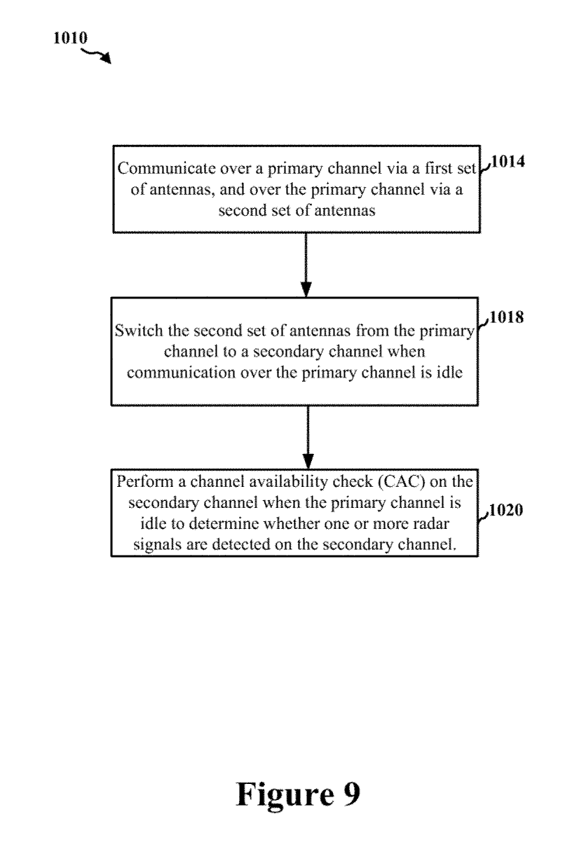

FIG. 9 is a flowchart showing an example method 1010 of performing background scanning with dynamic time and frequency switching in accordance with one or more techniques described herein. The method 1010 may be performed using an apparatus (e.g., a WLAN AP, a UE, or a STA that implements Wi-Fi-Direct and/or soft AP modes, or any other device configured to perform one or more techniques described herein) such as the AP 504.

At block 1014, the method performs communications over the primary channel via a first set of antennas and over the primary channel via a second set of antennas. The first set of antennas may include one or more antennas. The second set of antennas may include one or more antennas. In the single channel mode, data communication is enabled over the primary channel only. In a channel bonding mode, data communication may be enabled over the primary channel and a tertiary channel.

At block 1018, the method switches the second set of antennas from the primary channel to a secondary channel when communication over the primary channel is idle. For example, when no data packets are received over the primary channel, the second set of antennas may be switched from the primary channel used for data communication to a secondary channel for performing a CAC on the secondary channel. In the channel bonding mode, the second set of antennas may be switched from the tertiary channel used for data communication to the secondary channel.

At block 1020, the method performs a CAC on the secondary channel when the primary channel is idle to determine whether one or more radar signals are detected on the secondary channel.

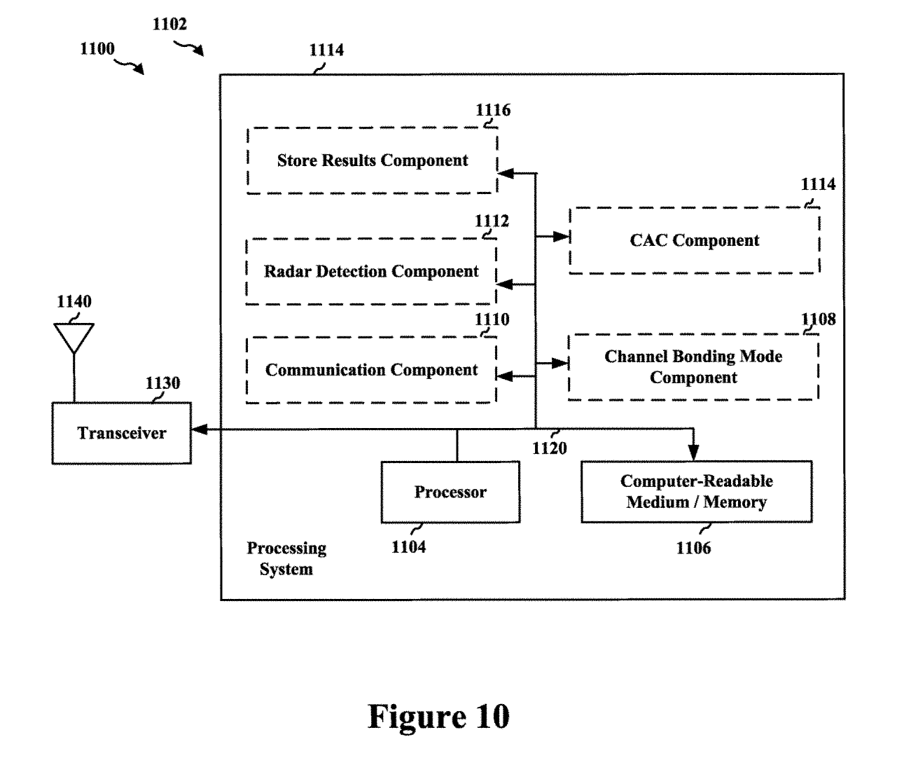

FIG. 10 is a diagram 1100 illustrating an example of a hardware implementation for an apparatus 1102 employing a processing system 1114. The processing system 1114 may be implemented with a bus architecture, represented generally by the bus 1120. The bus 1120 may include any number of interconnecting buses and bridges depending on the specific application of the processing system 1114 and the overall design constraints. The bus 1120 links together various circuits including one or more processors and/or hardware components, represented by the processor 1104, the components 1108, 1110, 1112, 1114, 1116, and the computer-readable medium/memory 1106. The bus 1120 may also link various other circuits such as timing sources, peripherals, voltage regulators, and power management circuits, which are well known in the art, and therefore, will not be described any further.

The processing system 1114 may be coupled to a transceiver 1130. The transceiver 1130 is coupled to one or more antennas 1140. The transceiver 1130 provides a means for communicating with various other apparatus over a transmission medium. The transceiver 1130 receives a signal from the one or more antennas 1140, extracts information from the received signal, and provides the extracted information to the processing system 1114. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the channel bonding mode component 1108, communication component 1110, radar detection component 1112, CAC component 1114 and store results component 1116. The components may be software components running in the processor 1104, resident/stored in the computer readable medium/memory 1106, one or more hardware components coupled to the processor 1104, or some combination thereof.

In one configuration, the apparatus 1102 for a mobile system includes means for operating in the channel bonding mode, means for communicating over the primary channel and over the primary channel or the tertiary channel, means for performing radar detection on the primary channel, means for performing a CAC on the secondary channel or the tertiary channel when the primary channel is idle, and means for storing results from the radar detection or the CAC. The aforementioned means may be one or more of the aforementioned components of the apparatus 1102 and/or the processing system 1114 of the apparatus 1102 configured to perform the functions recited by the aforementioned means.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication by an access point (AP), comprising:
communicating over a primary channel via a first set of antennas and over the primary channel via a second set of antennas;
switching the second set of antennas from the primary channel to a secondary channel when the communicating over the primary channel is idle; and
performing a channel availability check (CAC) on the secondary channel when the primary channel is idle to determine whether one or more radar signals are detected on the secondary channel.

2. The method of claim 1, further comprising simultaneously performing the CAC on both the primary channel and the secondary channel when the communicating over the primary channel is idle to determine whether one or more radar signals are detected via the first set of antennas being tuned to the primary channel and via the second set of antennas being tuned to the secondary channel.

3. The method of claim 1, further comprising transmitting an indication that the AP is providing a network service in a single channel mode while the AP operates in the channel bonding mode, wherein the single channel mode enables the AP to provide the network service over the primary channel via both the first set of antennas and the second set of antennas.

4. The method of claim 1, further comprising:
maintaining or interrupting communication on the primary channel on a packet-by-packet basis based on a first-come-first-served priority for arrival of a data packet at the primary channel or an arrival of a radar pulse at the secondary channel when performing the CAC on the secondary channel.

5. The method of claim 1, wherein switching the second set of antennas from the primary channel to the secondary channel comprises:
tuning the second set of antennas to the secondary channel during periods of inactivity on a packet-by-packet basis on the primary channel based on traffic duration at the primary channel, wherein the second set of antennas are switched in time and frequency.

6. The method of claim 1, further comprising transmitting an indication that the AP is providing a network service in a channel bonding mode.

7. The method of claim 6, wherein the AP is communicating over the first set of antennas tuned to the primary channel and over the second set of antennas tuned to a tertiary channel, wherein the CAC on the secondary channel is performed when the primary channel and the tertiary channel are idle, and the second set of antennas is switched from the tertiary channel to the secondary channel.

8. The method of claim 1, further comprising generating a channel availability list based on results from the CAC.

9. The method of claim 8, wherein the generating the channel availability list (CAL) comprises:
storing an indication of the secondary channel in the CAL when radar signals are absent from the secondary channel;
associating secondary channel to a next channel to be monitored; and
performing the CAC on the secondary channel for a time duration, the secondary channel being the next channel to be monitored.

10. The method of claim 1, further comprising:
performing radar detection on the primary channel to determine if one or more radar signals are detected on the primary channel via the first set of antennas; and
generating a non-occupancy list (NOL) based on results from the radar detection and the CAC.

11. The method of claim 10, wherein the generating the non-occupancy list (NOL) comprises:
storing a first indication of the primary channel in the NOL when one or more radar signals are detected on the primary channel; and
storing a second indication of the secondary channel in the NOL when one or more radar signals are detected on the secondary channel.

12. The method of claim 11, wherein the generating the NOL further comprises:
masking a subset of tones of a channel on which one or more radar signals are detected and making available for communication a remaining set of tones determined to be free from radar signals.

13. The method of claim 1, wherein data is communicated over the primary channel, the method further comprising:
performing radar detection on the primary channel to determine if one or more radar signals are detected on the primary channel via the first set of antennas; and
switching at least one of the primary channel or a primary channel bandwidth when one or more radar signals are detected on the primary channel, wherein switching the primary channel bandwidth comprises switching to a bandwidth less than a channel bandwidth of the primary channel.

14. The method of claim 1, wherein switching the second set of antennas from the primary channel to the secondary channel comprises:
switching the second set of antennas from the primary channel to the secondary channel for performing the CAC at a start of each of a plurality of random time slots; and
switching the second set of antennas from the secondary channel back to the primary channel for the communicating at an end of each of the plurality of random time slots.

15. The method of claim 13, wherein the primary channel is switched to an available channel in a channel availability list (CAL), and wherein the switch to the available channel in the CAL occurs without a further CAC performed on the available channel after one or more radar signals are detected on the primary channel.

16. The method of claim 7, wherein data is communicated over the first set of antennas tuned to the primary channel and over the second set of antennas tuned to the tertiary channel, the method further comprising:
performing radar detection on the primary channel to determine if one or more radar signals are detected on the primary channel via the first set of antennas;
performing radar detection on the tertiary channel to determine if one or more radar signals are detected on the tertiary channel via the second set of antennas; and
performing at least one of:
switching at least one of the primary channel or a primary channel bandwidth when one or more radar signals are detected on the primary channel; and
switching at least one of the tertiary channel or a tertiary channel bandwidth when one or more radar signals are detected on the tertiary channel.

17. The method of claim 16, wherein the primary channel bandwidth is switched to a first bandwidth less than a previous primary channel bandwidth, and wherein the tertiary channel bandwidth is switched to a tertiary bandwidth less than a previous tertiary channel bandwidth.

18. The method of claim 16, wherein the primary channel and the tertiary channel are switched to a first available channel and a second available channel, respectively, in a channel availability list (CAL) without a further CAC performed on both the first available channel and the second available channel after one or more radar signals are detected on the primary channel and the tertiary channel.

19. The method of claim 13, wherein the primary channel is switched to the secondary channel while the secondary channel is monitored for one or more radar signals, and wherein the switching to the secondary channel occurs without a further CAC performed on secondary channel after one or more radar signals are detected on the primary channel.

20. The method of claim 13, wherein the switching is based on at least one of a required network throughput or a type of traffic on the primary channel.

21. The method of claim 7, further comprising:
performing radar detection on the primary channel to determine if one or more radar signals are detected on the primary channel via the first set of antennas;
performing radar detection on the tertiary channel to determine if one or more radar signals are detected on the tertiary channel via the second set of antennas; and
changing from the channel bonding mode to a single channel mode when one or more radar signals are detected on either the primary channel or the tertiary channel.

22. The method of claim 21, the changing comprises performing at least one of:
communicating only in the primary channel when one or more radar signals are detected on the tertiary channel by switching the second set of antennas from the tertiary channel to the primary channel; and
switching the first set of antennas from the primary channel to the tertiary channel when one or more radar signals are detected on the primary channel.

23. The method of claim 21, further comprising changing from the single channel mode to the channel bonding mode when radar signals are absent from the secondary channel and devices capable of supporting the channel bonding mode are detected.

24. The method of claim 7, further comprising:
performing a fast channel switch between the secondary and tertiary channels, wherein performing the fast channel switch comprises modulating a time duration for listening to a data packet at one of the primary channel or the tertiary channel and listening to a radar pulse at the secondary channel based on traffic on one of the primary channel or the tertiary channel and a statistical criterion for radar detection, wherein the modulating a time duration comprises switching the second set of antennas from the secondary channel to the tertiary channel when the data packet is confirmed received at one of the primary channel or the tertiary channel.

25. The method of claim 24, further comprising transmitting an indication of a request to send (RTS)/clear to send (CTS) policy explicitly or implicitly, wherein the RTS/CTS policy enables an indication of a larger bandwidth to be used for subsequent communication in single channel mode or channel bonding mode, wherein the indication is provided in a CTS message.

26. The method of claim 24, further comprising:
performing radar detection on the primary channel to determine if one or more radar signals are detected on the primary channel via the first set of antennas;
performing radar detection on the tertiary channel to determine if one or more radar signals are detected on the tertiary channel via the second set of antennas;
switching the primary channel to the secondary channel if the secondary channel is free from radar signals and one or more radar signals are detected on the primary channel; and
switching the tertiary channel to the secondary channel if the secondary channel is free from radar signals and no radar signals are detected on the primary channel or to an available channel after performing CAC on the available channel when one or more radar signals are detected on the tertiary channel.

27. The method of claim 1, further comprising:
performing radar detection on the primary channel to determine if one or more radar signals are detected on the primary channel via the first set of antenna, wherein results from the radar detection indicate either the primary channel is free from radar or one or more radar signals are detected on at least one segment of the primary channel, and wherein results from the CAC indicate either the secondary channel is free from radar or one or more radar signals are detected on at least one segment of the secondary channel.

28. An access point for wireless communication, comprising:
means for communicating over a primary channel via a first set of antennas and over the primary channel via a second set of antennas;
means for switching the second set of antennas from the primary channel to a secondary channel when communication over the primary channel is idle; and
means for performing a channel availability check (CAC) on the secondary channel when the primary channel is idle to determine whether one or more radar signals are detected on the secondary channel.

29. An access point for wireless communication, comprising:
a memory; and
at least one processor coupled to the memory and configured to:
communicate over a primary channel via a first set of antennas and over the primary channel via a second set of antennas;
switch the second set of antennas from the primary channel to a secondary channel when communication over the primary channel is idle; and
perform a channel availability check (CAC) on the secondary channel when the primary channel is idle to determine whether one or more radar signals are detected on the secondary channel.

30. A computer-readable medium of an access point (AP) storing computer executable code, comprising code to:
communicate over a primary channel via a first set of antennas and over the primary channel via a second set of antennas;
switch the second set of antennas from the primary channel to a secondary channel when communication over the primary channel is idle; and
perform a channel availability check (CAC) on the secondary channel when the primary channel is idle to determine whether one or more radar signals are detected on the secondary channel.
